(19) United States
(12) Patent Application Publication
(10) Pub. No.: US 2021/0261155 A1
(43) Pub. Date: Aug. 26, 2021

(54) Device and method for managing block chain-based distribution-type autonomous travel information

(71) Applicant: Moo Young Jung, Anyang (KR)

(72) Inventor: Moo Young Jung, Anyang (KR)

(21) Appl. No.: 17/257,571

(22) PCT Filed: Jul. 9, 2019
(86) PCT No.: PCT/KR2019/008405

§ 371 Date: Jan. 2, 2021

(30) Foreign Application Priority Data
Jul. 10, 2018 (KR) 10-2018-0079818

(51) Int. Cl. B60W 60/00; H04L 9/06; H04W 4/46; H04W 4/029

(52) U.S. Cl. CPC B60W 60/001; H04L 9/0643; H04L 2209/84; H04W 4/029; H04L 2209/38; H04W 4/46

(57) ABSTRACT

The present invention pertains to a device and method which manage block chain-based distribution-type autonomous travel information and which perform data verification by determining whether data matches between autonomous traveling vehicles that share autonomous travel information. The device includes: a data collection unit which collects, from at least one autonomous traveling vehicle, autonomous travel information including autonomous travel start time information and autonomous travel end time information; a data storage unit which stores the autonomous travel information collected by the data collection unit; and a block chain calculation unit which generates a new block for each block generation period on the basis of the autonomous travel information stored in the data storage unit, and links the generated new block with existing block chain data in chain form. The block chain calculation unit includes a data verification unit which compares pieces of autonomous travel information collected by the data collection unit. When the pieces of autonomous travel information do not match, the data verification unit recognizes, as valid data, pieces of autonomous travel information that match by at least a certain ratio from among the collected pieces of autonomous travel information, and updates, to the recognized valid data, the autonomous travel information that does not match. Travel history information about the autonomous traveling vehicle is stored in a highly reliable storage space by the block chain-based distribution-type autonomous travel information management device which generates new blocks on the basis of autonomous travel information verified by the data verification unit and thus, accurate information can be quickly provided when needed.

### CROSS-REFERENCE TO RELATED APPLICATIONS

This application is a National Phase of the International Application No. PCT/KR2019/008405 filed on Jul. 9, 2019 which is based on Korean Application No. 10-2018-0079818 filed on Jul. 10, 2018 (now Korean Registered Patent. No. 10-2031241-B1). The applications are incorporated herein by reference.

### TECHNICAL FIELD

The present invention relates to an apparatus and method for blockchain-based distributed autonomous driving data management. More specifically, the invention relates to a blockchain-based distributed autonomous driving data management apparatus and method for performing data validation by comparing data from autonomous vehicles that share autonomous driving data to see if said data match.

### BACKGROUND ART

Recent years have seen growth in the development and distribution of autonomous cars.

An autonomous driving system used in cars is a system that autonomously drives the car to a given destination by allowing the car to sense its environment on the road on its own and assess the current driving situation and by controlling the car so it follows pre-programmed routes

If an autonomous car accident or loss occurs, the car manufacturer, the car owner, the affected victim, and the insurance company will investigate the accident to determine each party's share of liability for the loss and damages. In this case, whether or not the car was driving at the time of the accident or loss can play a pivotal role in determining such liability.

Currently, data about whether or not the car is driving autonomously are kept in the records of the autonomous vehicle and the car manufacturer that remotely monitors the car. Therefore, one has to rely on the records provided by the autonomous vehicle or the car manufacturer to determine the liability and damages for property damage or injury.

However, when autonomous vehicles increase in numbers in response to technological advancements and growing demand, one will face limitations in relying solely on car owners and manufacturers to provide records in terms of their reliability and accuracy.

Furthermore, the process of validating the authenticity of recorded data will inevitably require human and material resources.

Accordingly, there arises a need for a technology that prevents tampering, destruction, and loss of data in order to keep to a minimum unfair avoidance of liability and damages that may occur.

Meanwhile, the advent of blockchain technology coincided with the first release of the Bitcoin software in 2009. Since then, the technology has gained currency with the growing adoption of electronic money, distributed ledger technology, and highly reliable data validation technologies.

Blockchain technology is a distributed data storage technology that stores data in blocks that are linked together to form a chain, and then stores the data in multiple copies on a network of computers simultaneously. It is also called a public ledger.

Among the advantages it offers, the technology sends a record of any transaction to all users participating in the transaction, instead of storing the transaction record in a server, and allows all the participants to share and compare their data, thereby making data forgery or tampering difficult.

### DETAILED DESCRIPTION

### Technical Problem

In view of the foregoing background, it is therefore an object of the present invention to provide an apparatus and method for storing the driving history data of an autonomous vehicle in a highly reliable storage space to enable prompt and accurate data delivery where necessary.

It is another object of the invention to provide an autonomous driving data management apparatus and method that can prevent tampering, destruction, and loss of driving history data previously stored in an autonomous vehicle.

### Solution to Problem

In order to solve the above-described problem, the present invention comprises the following:

According to an embodiment of the present invention, a blockchain-based distributed autonomous driving data management apparatus comprises a data collection unit which collects autonomous driving data from at least one autonomous vehicle, including autonomous driving start time data and autonomous driving end time data; a data storage unit which stores the autonomous driving data stored by the aforementioned data collection unit, and a blockchain operation unit which creates new blocks based on the autonomous driving data stored in the aforementioned data storage unit during each cycle of block generation and links the aforementioned new blocks to existing blockchain data in the form of a chain, wherein the aforementioned blockchain operation unit comprises a data validation unit, which compares autonomous driving data collected by the aforementioned data collection unit and, in the event of a data mismatch, senses as valid data any of collected autonomous driving data whose match rate equals or exceeds a certain threshold while updating mismatched autonomous driving data to valid data, and the aforementioned data validation unit creates new blocks based on validated autonomous driving data.

According to one aspect of the invention, the data validation unit compares blockchain data received from at least one (1) autonomous vehicle and, in the event of a data mismatch, senses as valid data any of received blockchain data whose match rate equals or exceeds a certain threshold while updating mismatched blockchain data to valid data, encrypting, and storing said data.

It is also characterized by further comprising an autonomous driving detection unit, which detects whether or not the car is driving autonomously, as well as the autonomous driving start time data and the autonomous driving end time data if the car is driving autonomously.

According to another aspect of the invention, the blockchain-based distributed autonomous driving data management apparatus further comprises a location sensing unit that senses the location of an autonomous vehicle based on the data acquired from at least one of a GPS (Global Positioning System), a WPS (Wi-Fi-based positioning system), and an IMU (Inertial Measurement Unit), while the aforementioned data collection unit is characterized by collecting additional autonomous driving data based on the location data sensed by the aforementioned location sensing unit, such as autonomous driving start location, autonomous driving end location, and autonomous driving route data.

According to yet another aspect of the invention, the blockchain-based distributed autonomous driving data management apparatus further comprises a black box that uses a camera to record at least a certain partial area of the surroundings of the autonomous vehicle and stores the recording, and is characterized by collecting additional autonomous driving data by obtaining data about the existence of video recordings from the black box.

Meanwhile, the blockchain-based distributed autonomous driving data management method of the present invention comprises: the step of collecting autonomous driving data from at least one autonomous vehicle, including autonomous driving start time data and autonomous driving end time data; the step of comparing the collected autonomous driving data and, in the event of a data mismatch, sensing as valid data any autonomous driving data whose match rate equals or exceeds a certain threshold; the step of updating mismatched autonomous driving data to valid data and then storing the data; the step of creating new blocks based on the aforementioned stored autonomous driving data during each cycle of block generation; and the step of linking the aforementioned new blocks to existing blockchain data in the form of a chain.

Moreover, the blockchain-based distributed autonomous driving data management method of the invention further comprises the step of sensing the location data of an autonomous vehicle and collects additional autonomous driving data based on the aforementioned location data, such as autonomous driving start location, autonomous driving end location, and autonomous driving route data.

### Advantages of Invention

The apparatus and method according to the invention enables prompt and accurate data delivery where necessary by distributing and storing the driving history data of an autonomous vehicle in multiple autonomous driving data management devices, which make up highly reliable storage space, instead of a single space.

Also, it is an advantage of the invention to provide the driving data management apparatus and method for autonomous vehicles which, in the event of a mismatch between different driving history data stored in an autonomous vehicle, senses as valid data any driving history data with a match rate higher than 50% and updates mismatched data to valid data.

It is another advantage of the invention that data on the routes of an autonomous vehicle and data on the existence of black box recordings can be distributed and stored in the autonomous driving data management device of another autonomous vehicle or investigation agency, in addition to the autonomous vehicle in question, which guarantees easy access to the data and allows a prompt accident/loss investigation and resolution.

### BRIEF DESCRIPTION OF DRAWINGS

FIG. 1 is a block diagram showing the structure of a blockchain-based distributed autonomous driving data management apparatus according to one embodiment of the present invention.

FIG. 2 is an illustration describing a blockchain-based distributed ledger according to one embodiment of the invention.

FIG. 3 is an illustration describing the operation of a distributed autonomous driving data management apparatus according to one embodiment of the invention.

FIG. 4 is a flow chart showing a blockchain-based distributed autonomous driving data management method according to one embodiment of the invention.

### PREFERRED EMBODIMENT(S) OF INVENTION

The terminology used in this specification is for the purpose of describing one particular embodiment only and is not intended to be limiting of the invention. Unless otherwise defined, all technical terms used herein have the same meaning as commonly understood by one of ordinary skill in the art to which this invention belongs, and are not to be interpreted as having a meaning that is too broad or too narrow.

The following is a detailed description of a preferred embodiment of the invention with reference to the accompanying drawings.

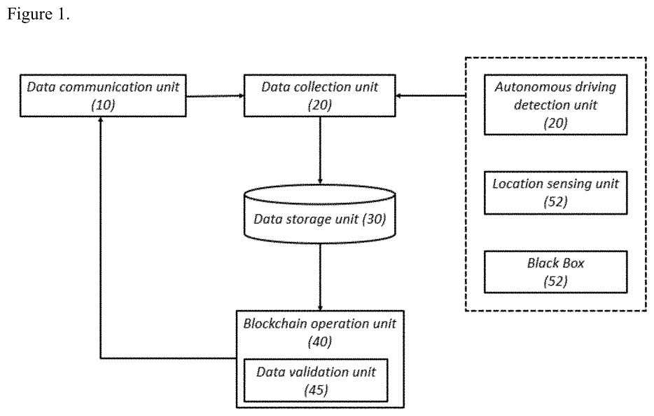

FIG. 1 is a block diagram showing the structure of a blockchain-based distributed autonomous driving data management apparatus according to one embodiment of the present invention.

According to the invention, the autonomous driving data management apparatus is preferably installed inside an autonomous vehicle in a location that is safe and stable in terms of temperature and humidity.

However, the invention is not limited to the technical structure in which the apparatus is installed inside an autonomous vehicle, but it can be embodied in a technical structure in which the apparatus is connected to a server run by a car manufacturer, an insurance company, a surveillance agency, or a blockchain operating agency so it can perform the management of autonomous driving data from autonomous vehicles that use the services of the organization in question.

In one embodiment, the autonomous driving data management apparatus is connected to an autonomous driving sensor or an autonomous driving input device already installed in the vehicle to sense the start and end of autonomous driving, determines the date and time through the timer, and temporarily records said date and time in the blockchain data storage device.

As shown in FIG. 1, according to one embodiment of the invention, the blockchain-based distributed autonomous driving data management apparatus comprises a data communication unit (10), a data collection unit (20), a data storage unit (30), a blockchain operation unit (40), and a data validation unit (45).

The data communication unit (10) performs the transferring of data to and from other autonomous vehicles and exchanges autonomous driving data with blockchain data, namely, a blockchain-based distributed ledger.

In one embodiment, the data communication unit (10) is interpreted as including a communication module that enables the transferring of data to and from other autonomous vehicles through various wired and wireless networks.

The data collection unit (20) collects autonomous driving data from at least one autonomous vehicle, including autonomous driving start time data and autonomous driving end time data.

In one embodiment, the data collection unit (20) can collect autonomous driving data about another autonomous vehicle from that other autonomous vehicle through the data communication unit (10).

The data storage unit (30) is embodied as a memory device capable of storing data and stores the autonomous driving data collected by the data collection unit (20).

The blockchain operation unit (40) creates new blocks based on the autonomous driving data stored in the data storage unit (30) during each cycle of block generation.

According to one embodiment, during each cycle of synchronization (approximately 10 minutes), the autonomous driving data management apparatus transfers and shares previously created blockchain data and newly created autonomous driving data from autonomous vehicles, including autonomous driving start and end times, with another autonomous driving data management device installed in another vehicle, a surveillance agency, or a blockchain operating agency.

The blockchain operation unit (40) combines all newly created autonomous driving data in one frame to form a block, which is combined with previously created blockchain data and waits to be become a chain-shaped data aggregate.

A block is a unit of data storage and divided into a body and a header. The body contains the details of a transaction while the header contains encryption codes, such as Merkle hash (Merkle root) and nonce (arbitrary number associated with encryption).

In each block, the previous hash created in the previous block is combined with the Merkle hash and nonce that are generated by hashing transactions to find a block hash value, and said block hash value becomes the previous hash in the next block. In this way, blocks make up a chain of data linked together.

In other words, if a transaction is randomly modified, the current block hash value will change, which in turn causes the previous hash value in the next block to change, which is why a random change in any past transaction data results in hash value changes in all subsequent blocks, as well as the block in which the original change has been made.

Also, in a blockchain network, any blockchain containing any invalid hash value will be rejected. Data are thus linked together and then validated.

Blocks are created during each cycle of block generation, for example, an interval of every 10 minutes.

The blockchain operation unit (40) gathers autonomous driving data and validates their reliability while performing blockchain-based autonomous driving data management by linking each new block to its previous block.

This is when the blockchain operation unit (40) links a newly created block to existing blockchain data in the form of a chain.

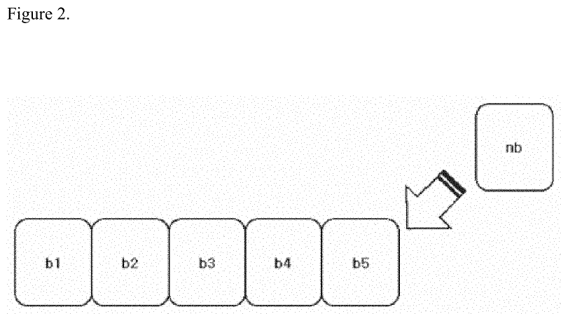

FIG. 2 is an illustration describing a blockchain-based distributed ledger according to one embodiment of the invention.

The blockchain operation unit (40) links a newly created block (nb) to blockchain data (b1 to b5) by having said new block (nb) receive a portion of the hash value of the previous block (b5) and store it in the header.

In other words, it can provide integrity that allows detection of an error or tampering of an input message by displaying the immutable evidence value of the message using a hash function.

According to one aspect of the invention, the blockchain operation unit (40) comprises a data validation unit (45). The data validation unit (45) compares autonomous driving data collected by the data collection unit (20) to see if they match.

Upon discovery of a data mismatch, said unit senses as valid data any collected autonomous driving data whose match rate equals or exceeds a certain threshold. It also updates mismatched autonomous driving data to valid data.

In one embodiment, the data validation unit (45) can sense as valid data any autonomous driving data with a match rate higher than 50%. However, the invention is not limited to this embodiment, but a threshold can be set higher than 50%, at which data begin to be seen as valid data, in order to increase the level of security.

In other words, autonomous driving data can be validated before any new block is created so that, when more than half the autonomous driving data match, a new block is created and stored in the blockchain ledger after being encrypted.

For example, if someone tries to hack or manipulate temporarily recorded autonomous driving data, that person has to change all of the autonomous driving data stored in more than half the autonomous driving data management devices within a 10-minute cycle of block generation. Because in reality it is difficult to change all such data, the reliability of data can be recognized.

According to another aspect of the invention, the data validation unit (45) compares blockchain data it receives from at least one autonomous vehicle to see if they match.

In the event of a mismatch, said unit senses as valid data any of received blockchain data whose match rate equals or exceeds a certain threshold, while updating mismatched blockchain data to valid data, encrypting, and storing said data.

The blockchain operation unit (40) can extend the chain of blockchain data by linking each newly created block to existing blockchain data, which has been validated by the data validation unit (45), in the form of a chain at an interval of 10 minutes.

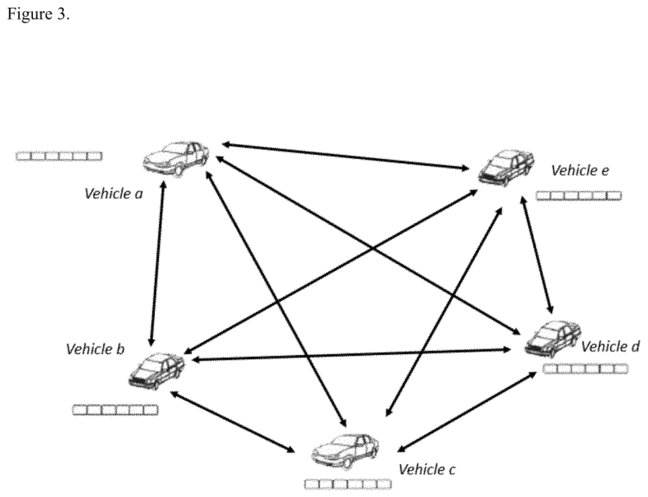

FIG. 3 is an illustration describing the operation of a distributed autonomous driving data management apparatus according to one embodiment of the invention.

The blockchain operation unit (40) installed in vehicle ‘a’ sends and shares blockchain data, which has been extended during each cycle of synchronization, to autonomous driving data management devices installed in other autonomous vehicles (vehicle b, vehicle c, vehicle d, and vehicle e).

According to one embodiment, the distributed autonomous driving data management apparatus updates the data to synchronized blockchain data by sharing said data to other autonomous driving data management devices, and then stores said data in the data storage unit (30).

In other words, said apparatus shares existing blockchain data, which have already been recorded through the transferring of data between at least more than one autonomous driving data management devices, and compares and analyzes the data during each cycle of synchronization.

Upon discovery of any block of a participant who has different data, only data from those participants (autonomous driving data management devices) are recognized to prevent alteration, forgery, omission, or loss of data.

Existing blockchain data that have already been validated will be distributed to all participants and updated in the data storage unit of the participant that has different data. Ultimately, all participants end up retaining identical data.

According to this algorithm, in order to erase or change data, each user has to erase or change the data in the block in question that have been recorded in the autonomous driving data management devices of more than half the participants within the period of synchronization (10 minutes) during which the next block is being created. In other words, if participants increase in diversity and in numbers, erasing or changing any data becomes impossible.

In another embodiment, the autonomous driving data management apparatus according to the present invention can be embodied so that blockchain data can be shared among pre-authorized user groups. Pre-authorized user groups can be embodied as autonomous driving data management devices installed in autonomous vehicles that have been manufactured by a certain company, or those vehicles that are covered by a certain insurance policy.

In other words, a private blockchain applies, which is operated by an organization or a company and can only be used by pre-authorized persons.

The blockchain operation unit (40), in particular, can present a group encryption code to a block to make it possible to verify whether or not it is an autonomous vehicle that belongs to the set group.

The data validation unit (45) can further verify whether or not data has been shared by a user group permitted to share said data, in addition to the validity of autonomous driving data and blockchain data.

According to another aspect of the invention, the autonomous driving data management apparatus further comprises an autonomous driving detection unit (50), a location sensing unit (52), and a black box (54).

The autonomous driving detection unit (50) detects whether or not the car is driving autonomously, as well as autonomous driving start time data and autonomous driving end time data if the car is driving autonomously. In one embodiment, the autonomous driving detection unit (50) can be embodied as an autonomous driving sensor. However, the invention is not limited to such an embodiment.

The location sensing unit (52) senses high-precision location data from an autonomous vehicle based on data obtained from at least one of a GPS (Global Positioning System), a WPS (Wi-Fi-based positioning system), and an IMU (Inertial measurement unit).

The location sensing unit (52) is preferably interpreted as encompassing all technical structures that are capable of sensing location data in autonomous vehicles, in addition to the technical structure described above.

The data collection unit (20) collects additional autonomous driving data based on location data sensed by the location sensing unit (52), such as autonomous driving start location, autonomous driving end location, and autonomous driving route data.

The black box (54) uses a camera to record at least a certain partial area of an autonomous vehicle and stores the recording. Also, the data collection unit (20) obtains data on the existence of a video recording from the black box (54) and collects it as additional autonomous driving data.

Preferably, the data collection unit (20) matches the existence of a video recording, the place and time of the recording and stores them as autonomous driving data. However, the invention is not limited to this embodiment, but it can also store video or photograph data as it is.

According to the aforementioned aspect, the invention allows a more accurate assessment of a situation when an accident or loss occurs by performing blockchain-based management of data, even the existence of any video recording of the autonomously driving car, in addition to whether the car is driving autonomously, start and end times, and location data.

It is also an advantage of the invention that, since data on the existence of a black box video recording is distributed to and stored in the autonomous driving data management device of another autonomous vehicle or an investigation agency, in addition to the autonomous vehicle in question, it guarantees easy access to the data and allows a prompt accident/loss investigation and resolution.

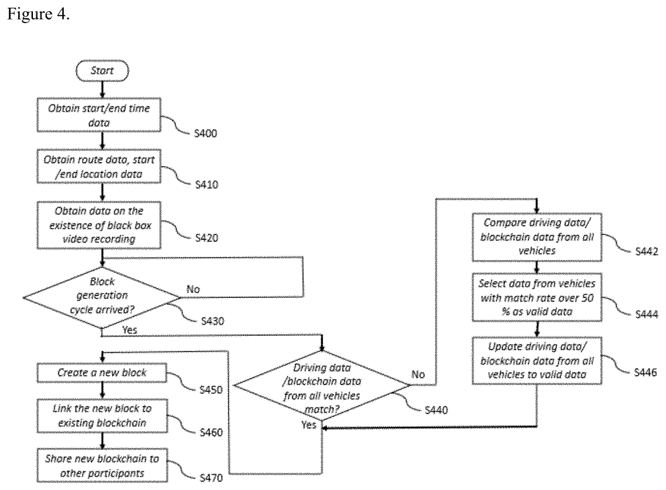

FIG. 4 is a flow chart showing a blockchain-based distributed autonomous driving data management method according to one embodiment of the invention.

The following is a description of the blockchain-based distributed autonomous driving data management method with reference to FIG. 4.

First, autonomous driving data, including whether or not the car is driving autonomously, autonomous driving start time data, and autonomous driving end time data, are collected from the autonomous driving management device of at least one autonomous vehicle (S400).

Then, the collected autonomous driving data are compared (S440, S442) and, in the event of a mismatch, any collected autonomous driving data whose match rate equals or exceeds a certain threshold are selected and sensed as valid data (S444).

When more than half the autonomous driving data match, said data can be sensed as valid data. However, the invention is not limited to this embodiment, but a threshold can be set higher than 50%, at which data begin to be seen as valid data, in order to increase the level of security.

In other words, autonomous driving data can be validated before any new block is created so that, when more than half the autonomous driving data match, a new block is created and stored in the blockchain ledger after being encrypted.

For example, if someone tries to hack or manipulate temporarily recorded autonomous driving data, that person has to change all of the autonomous driving data stored in more than half the autonomous driving data management devices within a 10-minute cycle of block generation. Because in reality it is difficult to change all such data, the reliability of data can be recognized.

And the autonomous driving data that do not match will be updated to valid data and stored as such (S446).

When a block generation cycle arrives (S430), a new block is created based on the stored autonomous driving data (S450).

The newly created autonomous driving data are combined in one frame to form a block, which is combined with previously created blockchain data and waits to be become a chain-shaped data aggregate.

For example, blocks are created during each cycle of block generation, for example, every 10 minutes.

Then, the newly created blocks are linked to existing blockchain data in the form of a chain (S460).

The autonomous driving data that have been updated to valid data are gathered to validate their reliability while blockchain-based autonomous driving data management is being performed by linking a new block to the previous block.

Also, the new blockchain data is shared to another participant, namely, an autonomous driving management device in each cycle of synchronization (S470).

According to one embodiment, the existing blockchain data and newly created autonomous driving data, including the autonomous driving start and end times of respective autonomous vehicles, are transferred and shared to autonomous driving data management devices installed at another vehicle, surveillance agency, or blockchain operating agency during each cycle of synchronization (approximately 10 minutes).

Also, the blockchain data received from at least one autonomous vehicle are compared to see if they match (S440) and in the event of mismatched blockchain data (S442), any received blockchain data whose match rate equals or exceeds a certain threshold are sensed as valid data (S444).

And the mismatched blockchain data are updated to valid data, encrypted, and stored (S446).

In other words, the chain of blockchain data can be extended by linking each newly created block to existing blockchain data, which has been validated, in the form of a chain at an interval of 10 minutes.

Also, the autonomous driving management method according to the invention obtains additional location data from autonomous vehicles (S410).

It can further contain additional autonomous driving data based on obtained location data, including autonomous driving start location, autonomous driving end location, and autonomous driving route data in addition to whether or not the car is driving autonomously, autonomous driving start time, and autonomous driving end time.

Furthermore, the autonomous driving management method according to the invention collects additional autonomous driving data from the black box, including the existence of any stored video recording of autonomous driving, by recording at least a partial area of the autonomous driving car (S420).

The place and time of the recording can be matched to the existence of the video before being stored. Also, it is possible to include video and photo data as autonomous driving data.

According to the aforementioned aspect, the invention allows a more accurate assessment of a situation when an accident or loss occurs by performing blockchain-based management of data, including even the existence of any video recording of the autonomously driving car, in addition to whether the car is driving autonomously, start and end times, and location data.

It is also an advantage of the invention that, since data on the existence of a black box video recording is distributed to and stored in the autonomous driving data management device of another autonomous vehicle or an investigation agency, in addition to the autonomous vehicle in question, it guarantees easy access to the data and allows a prompt accident/loss investigation and resolution.

Description of Symbols

| | | | |
|---|---|---|---|
| 10: | Data communication unit | 20: | Data collection unit |
| 30: | Data storage unit | 40: | Blockchain operation unit |
| 45: | Data validation unit | 50: | Autonomous driving detection unit |
| 52: | Location sensing unit | 54: | Black box |

What is claimed is:

1. A blockchain-based distributed autonomous driving data management apparatus comprising:
a data collection unit which collects autonomous driving data from at least one autonomous vehicle, including autonomous driving start time data and autonomous driving end time data;
a data storage unit which stores the autonomous driving data stored by the aforementioned data collection unit; and
a blockchain operation unit which creates new blocks based on the autonomous driving data stored in the aforementioned data storage unit during each cycle of block generation and links the aforementioned new blocks to existing blockchain data in the form of a chain,
wherein the aforementioned blockchain operation unit comprises
a data validation unit, which compares autonomous driving data collected by the aforementioned data collection unit and, in the event of a data mismatch, senses as valid data any of collected autonomous driving data whose match rate equals or exceeds a certain threshold while updating mismatched autonomous driving data to valid data, and
the aforementioned data validation unit creates new blocks based on validated autonomous driving data.

2. The blockchain-based distributed autonomous driving data management apparatus of claim 1, wherein the aforementioned data validation unit compares blockchain data received from at least one autonomous vehicle and, in the event of a data mismatch, senses as valid data any of collected autonomous driving data whose match rate equals or exceeds a certain threshold, while updating mismatched autonomous driving data to valid data, encrypting, and storing said data.

3. The blockchain-based distributed autonomous driving data management apparatus of claim 1, wherein it further comprises an autonomous driving detection unit, which detects whether or not the car is driving autonomously, autonomous driving start time data and the autonomous driving end time data if the car is driving autonomously.

4. The blockchain-based distributed autonomous driving data management apparatus of claim 1, wherein it further comprises a location sensing unit that senses the location of an autonomous vehicle based on the data acquired from at least one of a GPS (Global Positioning System), a WPS (Wi-Fi-based positioning system), and an IMU (Inertial Measurement Unit), while the aforementioned data collection unit is characterized by collecting additional autonomous driving data based on the location data sensed by the aforementioned location sensing unit, such as autonomous driving start location, autonomous driving end location, and autonomous driving route data.

5. The blockchain-based distributed autonomous driving data management apparatus of claim 1, wherein it further comprises a black box that uses a camera to record at least a certain partial area of the surroundings of the autonomous vehicle and stores the recording, and
the aforementioned data collection unit is characterized by collecting additional autonomous driving data by obtaining data about the existence of video recordings from the black box.

6. A blockchain-based distributed autonomous driving data management method characterized by comprising:
the step of collecting autonomous driving data from at least one autonomous vehicle, including autonomous driving start time data and autonomous driving end time data;
the step of comparing the collected autonomous driving data and, in the event of a data mismatch, sensing as valid data any autonomous driving data whose match rate equals or exceeds a certain threshold;
the step of updating mismatched autonomous driving data to valid data and then storing the data;
the step of creating new blocks based on the aforementioned stored autonomous driving data during each cycle of block generation; and
the step of linking the aforementioned new blocks to existing blockchain data in the form of a chain.

7. The blockchain-based distributed autonomous driving data management method of claim 6, wherein it further comprises the step of comparing blockchain data received from at least one autonomous vehicle and, in the event of a mismatch, sensing any received blockchain data whose match rate equals or exceeds a certain threshold; and the step of updating mismatched blockchain data to the aforementioned valid data, encrypting and storing said data.

8. The blockchain-based distributed autonomous driving data management method of claim 7, wherein it further comprises the step of sensing location data of autonomous vehicles, while the aforementioned step of collection is characterized by
collecting additional autonomous driving data based on the aforementioned location data, including autonomous driving start location, autonomous driving end location, and autonomous driving route data.
